(19) United States
(12) Patent Application Publication
(10) Pub. No.: US 2005/0264484 A1
(43) Pub. Date: Dec. 1, 2005

(54) Method for expressing gray scale of plasma display panel and plasma display device

(76) Inventors: Seung-Hun Chae, Suwon-si (KR); Woo-Joon Chung, Suwon-si (KR); Jin-Sung Kim, Suwon-si (KR); Jin-Ho Yang, Suwon-si (KR); Tae-Seong Kim, Suwon-si (KR)

Correspondence Address: CHRISTIE, PARKER & HALE, LLP, PO BOX 7068, PASADENA, CA, 91109-7068, US

(21) Appl. No.: 11/132,503

(22) Filed: May 18, 2005

(30) Foreign Application Priority Data
May 25, 2004 (KR) 10-2004-0037284

(51) Int. Cl. G09G 3/28

(52) U.S. Cl. 345/63

(57) ABSTRACT

A plasma display device including a plasma display panel having a plurality of discharge cells and expressing gray scales in the plurality of discharge cells using a sum of weight values of subfields that are selected to be turned on from among a plurality of subfields. The plasma display device includes a controller for selecting subfields of which the discharge cells are to be turned on from among the plurality of subfields according to input gray scales, wherein when arranging subfields to express gray scales from a gray scale of 1 to a given gray scale, the controller controls an arrangement of subfields such that no discharge cell remains turned off for more than two consecutive subfields and is then turned on in another subfield of the same field.

### CROSS REFERENCE TO RELATED APPLICATION

This application claims priority to and the benefit of Korean Patent Application No. 10-2004-0037284 filed on May 25, 2004 in the Korean Intellectual Property Office, the entire content of which is incorporated herein by reference.

### BACKGROUND OF THE INVENTION

1. Field of the Invention

The present invention relates to a method for displaying gray scales of a plasma display panel, and more particularly relates to a method for displaying gray scales by combining respective weight values of a plurality of subfields.

2. Background of the Related Art

As well known in the art, a plasma display device uses a plasma display panel (PDP) using plasma generated by gas discharge to display characters or an image thereon. The PDP has from several hundreds of thousands to several millions of pixels (discharge cells) in a matrix format. PDPs are categorized as direct current (DC) type PDPs or alternating current (AC) type PDPs, according to supplied driving voltage waveforms and discharge cell structures.

As shown in FIG. 1, the AC type PDP includes a number of electrodes that define n×m discharge cells in a matrix format. In more detail, address electrodes A1 to Am are elongated (i.e., extend) in a column direction, and scan electrodes Y1 to Yn and sustain electrodes X1 to Xn are elongated in a row direction. As can be seen in FIG. 1, a discharge cell 12 is defined by a pair of scan and sustain electrodes and an address electrode crossing the pair of the scan and sustain electrodes.

In the AC type PDP, one field (i.e., one TV field) is divided into a plurality of subfields and the subfields are assigned with respective weight values. A gray scale is expressed by a sum of the weight values assigned to the subfields which are selected to display among the plurality of subfields. Each subfield includes a reset period, an address period, and a sustain period. In the address period, discharge cells are selected to be turned on during the corresponding subfield. In the sustain period, the discharge cells selected in the address period are sustain-discharged during a period corresponding to a weight value of the corresponding subfield.

In the address period, scan pulses are sequentially applied to scan electrodes Y1 to Yn to select turn-on discharge cells (i.e., cells to be turned on). When the scan pulse is applied to a scan electrode Y1, an address pulse is applied to an address electrode that passes through the turn-on discharge cell selected among discharge cells formed on the scan electrode Y1. A discharge is then generated in the discharge cell applied with the scan pulse and the address pulse, and thus a wall voltage is formed. As described above, the scan pulses are sequentially applied to the scan electrodes Y1 to Yn so as to select the turn-on discharge cells. When a sustain discharge pulse is commonly applied to the scan electrodes Y1 to Yn and the sustain electrodes X1 to Xn, a sustain discharge is generated in the discharge cell in which the wall voltage is formed during the address period.

Since a length of a field is fixed, a length of the address period for each subfield may also be fixed. For example, when the scan electrodes Y1 to Yn are set to be 480 lines, a width of the scan pulse is reduced to sequentially apply 480 scan pulses to 480 scan electrodes within the fixed address period. However, the discharge is generated in the discharge cell after a delay and not immediately when the scan pulse and the address pulse are applied to the discharge cell. Accordingly, when the discharge is generated at or after an end of the scan pulse, the discharge becomes weaker than a normally generated discharge. In this case, the wall voltage cannot be normally formed in the discharge cell such that a weak sustain discharge (i.e., so called a weak discharge) is generated in the sustain period.

The information disclosed in this Background of the Invention section is only for enhancement of understanding of the background of the invention, and therefore, unless explicitly described to the contrary, it should not be taken as an acknowledgement or any form of suggestion that this information forms the prior art that is already known in this country to a person of ordinary skill in the art.

### SUMMARY OF THE INVENTION

In exemplary embodiments according to the present invention, a method for expressing gray scales of a plasma display panel and a plasma display device thereof, are provided. The method has a feature of expressing gray scales by reducing a delay of a discharge in an address period to thereby prevent a weak discharge from being generated.

In an exemplary embodiment according to the present invention, a method for expressing gray scales in a plasma display panel using a sum of weight values of a plurality of subfields of turn-on cells is provided. In the method, weight values of a first subfield and a second subfield among the plurality of subfields are respectively determined and a weight value of an n-th subfield among the plurality of subfields, where n is an integer greater than or equal to 3, is set to be less than or equal to a sum of weight values of an (n−1)th subfield and an (n−2)th subfield among the plurality of subfields. The determining of the weight value of the n-th subfield is repeated until a weight value of a given subfield is determined.

The weight value of the n-th subfield may be set to be equal to the sum of the weight values of the (n−1)th subfield and the (n−2)th subfield.

The weight values of the first subfield and the second subfield may be respectively set to be 1 and 2.

The weight values of the first subfield and the second subfield may be respectively set to be 1.

The subfields having the determined weight values of the first and second subfields and the n-th subfield may be arranged according to sizes of the weight values.

When a gray scale is expressed by a sum of the weight values of subfields having the turn-on cells from among the arranged subfields, a position difference between two adjacent subfields having the turn-on cells may be less than or equal to 2.

In another exemplary embodiment according to the present invention, a plasma display device includes a plasma display panel and a controller. The plasma display panel has a plurality of discharge cells and express gray scales in the plurality of discharge cells using a sum of weight values of subfields selected from among a plurality of subfields having respective weight values. The controller selects subfields of which the discharge cells are to be turned on from among the plurality of subfields according to input gray scales.

When arranging subfields to express gray scales from a gray scale of 1 to a given gray scale, the controller controls an arrangement of the subfields such that no discharge cell remains turned off for more than two consecutive subfields and is then turned on in another subfield of a same field.

The controller may control the weight values of a first subfield and a second subfield among the plurality of subfields to be 1, respectively.

The controller may control the weight values of a first subfield and a second subfield among the plurality of subfields to be 1 and 2, respectively.

The controller may control the weight value of an n-th subfield to be less than or equal to a sum of the weight values of an (n−1)th subfield and an (n−2)th subfield.

The controller may control the weight value of an n-th subfield to be equal to a sum of the weight values of an (n−1)th subfield and an (n−2)th subfield.

In yet another exemplary embodiment according to the present invention, a method for expressing gray scales in a plasma display panel having a plurality of discharge cells, using a sum of weight values of a plurality of subfields of turned-on discharge cells among the plurality of discharge cells, is provided. According to the method, the weight values of the subfields are determined such that the weight values of each subfields except for first and second subfields is less than or equal to a sum of the weight values of two previous subfields among the plurality of subfields when the subfields are arranged in an increasing order of their respective weight values.

### BRIEF DESCRIPTION OF THE DRAWINGS

FIG. 1 is an electrode arrangement diagram of a plasma display panel (PDP).

FIG. 2 schematically illustrates a PDP according to an exemplary embodiment of the present invention.

FIG. 3A and FIG. 3B respectively show an address discharge delay time according to a turn-on state of each subfield.

FIG. 4 illustrates an exemplary subfield arrangement according to an exemplary embodiment of the present invention.

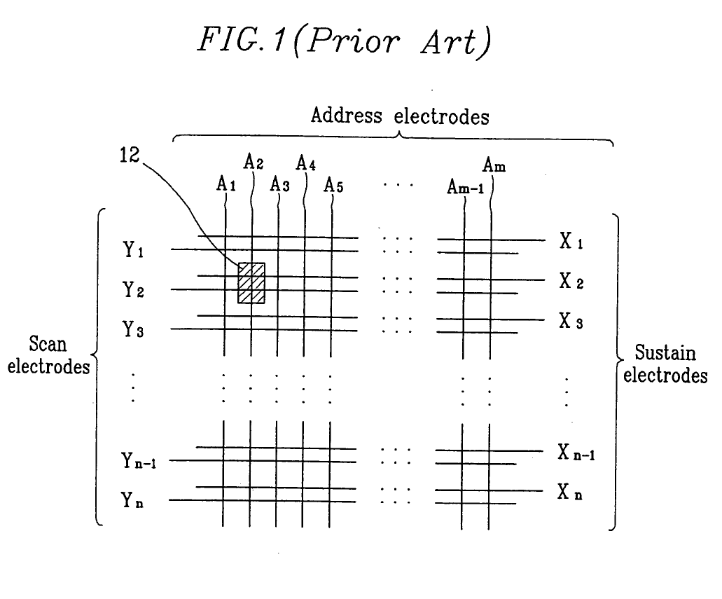

### DETAILED DESCRIPTION

In the following detailed description, only certain exemplary embodiment of the present invention has been shown and described, simply by way of illustration. As those skilled in the art would realize, the described embodiments may be modified in various different ways, all without departing from the spirit or scope of the present invention. Accordingly, the drawings and description are to be regarded as illustrative in nature, and not restrictive.

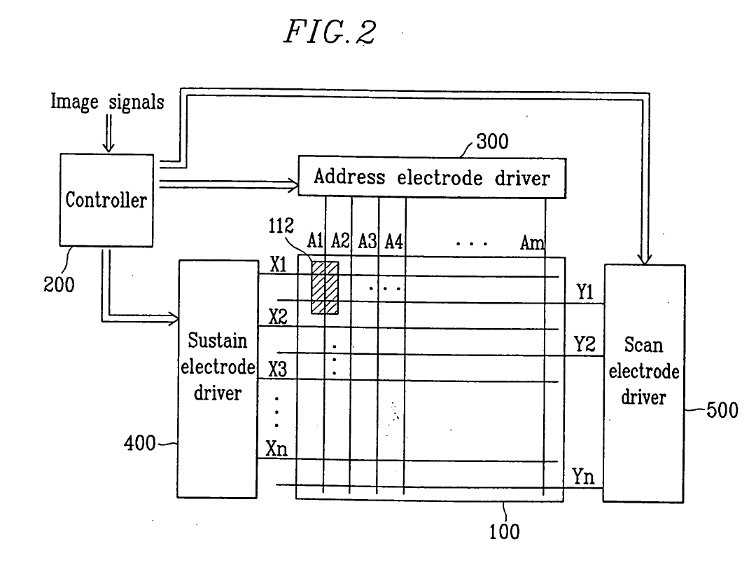

FIG. 2 schematically illustrates a plasma display device according to an exemplary embodiment of the present invention.

As shown in FIG. 2, the plasma display device includes a plasma display panel (PDP) 100, a controller 200, an address electrode driver 300, a sustain electrode driver 400, and a scan electrode driver 500. These drivers may alternatively be referred to as an address driver 300, an X electrode driver 400 and a Y electrode driver 500, respectively.

The PDP 100 includes a plurality of address electrodes A1 to Am extending in a column direction, and a plurality of sustain electrodes X1 to Xn and scan electrodes Y1 to Yn extending in a row direction in pairs. The sustain electrodes X1 to Xn are formed in correspondence to the scan electrodes Y1 to Yn, respectively. Here, a discharge cell 112 is formed by a discharge space at each intersection of the address electrodes A1 to Am, the sustain electrodes X1 to Xn, and the scan electrodes Y1 to Yn.

The controller 200 selects a subfield having a turn-on discharge cell from among a plurality of subfields based on externally input image signals (i.e., gray scales), and outputs an address electrode driving control signal, a sustain electrode driving control signal, and a scan electrode driving control signal. When arranging the subfields to express gray scales from a gray scale of 1 to a given gray scale, the controller 200 controls a sequence of the subfields such that no discharge cell remains turned off for more than two consecutive subfields and is then turned on in another subfield of the same field. In particular, the controller 200 sets a weight value of an n-th subfield to be less than or equal to a sum of weight values of (n−1)th and (n−2)th subfields.

The address electrode driver 300, the sustain electrode driver 400, and the sustain electrode driver 500 respectively receive driving control signals from the controller 200, and respectively apply driving voltages to the address electrodes A1 to Am, the sustain electrodes X1 to Xn, and the scan electrodes Y1 to Yn in each subfield.

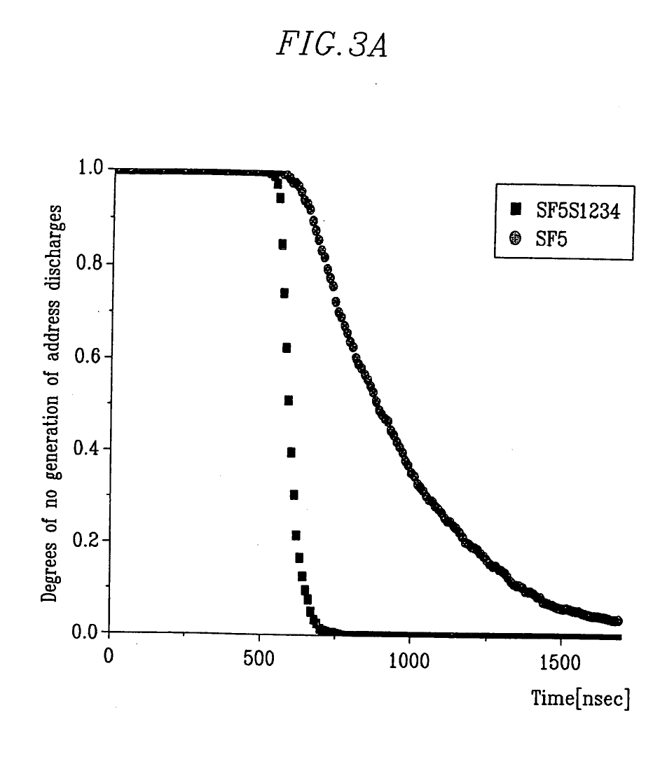

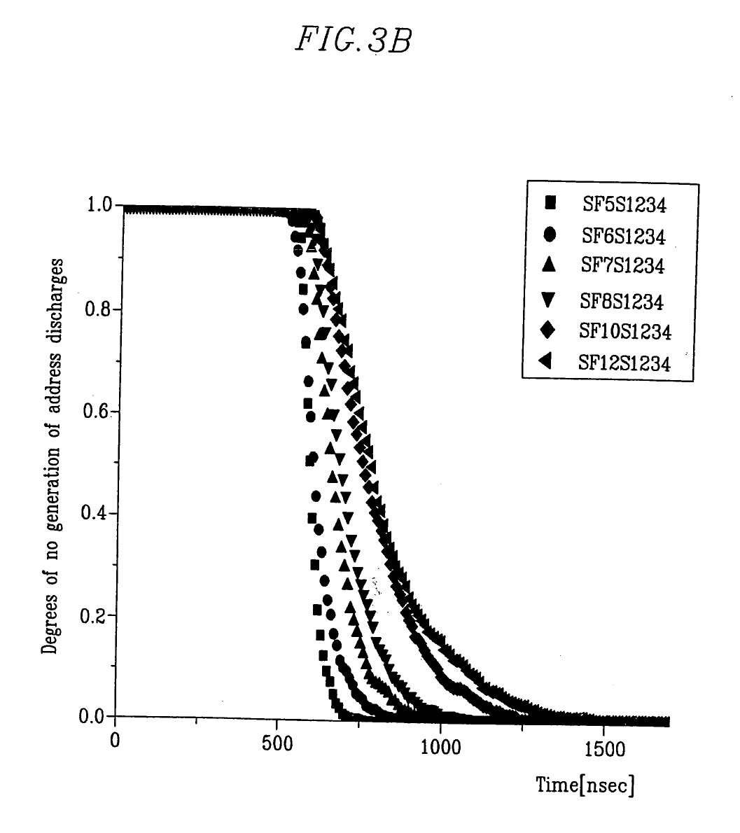

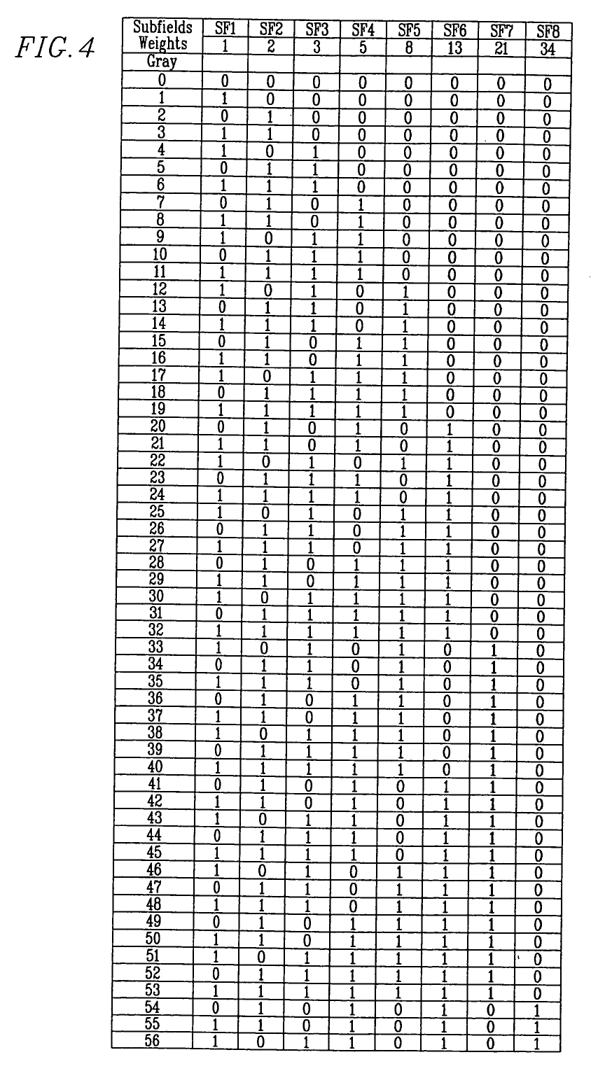

A method for forming a subfield in the controller 200 of the PDP according to an exemplary embodiment of the present invention will be described with reference to FIG. 3A to FIG. 4.

FIG. 3A and FIG. 3B respectively illustrate a delay of an address discharge when a subfield is in a turn-on state.

The delay of the address discharge according to a state of a previous subfield will be hereinafter described with reference to FIG. 3A and FIG. 3B. As shown therein, a horizontal axis denotes a discharge delay time in nano seconds (ns). The discharge delay time represents a time taken for intensity of a discharge to become maximal after a scan pulse is applied to a discharge cell. A vertical axis denotes a normalized value of the number of discharge cells in which a discharge is generated but intensity of the discharge does not reach the highest level as time passes. For example, when 210 discharge cells among 300 discharge cells do not have achieved maximal discharge during 600 nsec, the normalized value corresponding thereto becomes 0.7.

FIG. 3A shows the delay of the address discharge in the case (“SF5S1234”) where the address discharge is generated in a fifth subfield SF5 when sustain discharges have been generated in first through fourth subfields SF1 to SF4 and in the case (“SF5”) where the address discharge is first generated in the fifth subfield SF5 while the sustain discharge has not been generated in any of the previous first to fourth subfields SF1 to SF4.

When the address discharge is generated in the fifth subfield SF5 after the sustain discharges were generated in the first to fourth subfields SF1 to SF4, intensity of the address discharge becomes the highest in approximately 700 ns for more than 90% of the discharge cells.

When the sustain discharge was not generated in the first to fourth subfields SF1 to SF4 and the address discharge is generated in the fifth subfield SF5, the intensity of the address discharge becomes the highest in approximately 1400 ns for more than 90% of the discharge cells.

In other words, the discharge delay time is changed depending on whether the address discharge was generated in previous subfields.

FIG. 3B shows a delay of the address discharge when the address discharge is generated in the fifth to eighth, the tenth, and the twelfth subfields SF5 to SF8 (“SF5S1234”, “SF6S1234”, “SF7S1234”, “SF8S1234”), SF10 (“SF10S1234”), and SF12 (“SF12S1234”), respectively, when sustain discharges have been generated in the first through fourth subfields SF1 to SF4.

As the number of subfields in which the address discharge is not generated after the first to fourth subfields SF1 to SF4 is increased, the delay of the address discharge becomes longer.

As shown in FIG. 3A and FIG. 3B, the discharge delay time is determined according to the number of successive subfields in which the address discharge is not generated.

In other words, as the number of subfields in which the address discharge is not consecutively generated increases, the discharge delay time becomes longer, and therefore, a weak discharge is more likely to occur. This implies that an amount of priming particles generated in a previous subfield determines the discharge delay time. In other words, when the address discharge has been consecutively generated in the previous subfields, the amount of the priming particle is increased and thus the discharge delay time is decreased. However, when the address discharge has not been consecutively generated in the previous subfields, no priming particle is generated and thus the discharge delay time is increased.

When arranging the subfields to express gray scales from a gray scale of 1 to a given gray scale, no discharge cell remains turned off for more than two consecutive subfields and is then turned on in another subfield of the same field, according to an exemplary embodiment of the present invention. A method for arranging subfields in the controller 200 according to an exemplary embodiment of the present invention will be described in more detail.

A plurality of subfields are arranged in a format such that weight values of subfields are not decremented, and weight values W₁ and W₂ of first and second subfields SF1 and SF2 are respectively determined.

The weight values W₁ and W₂ Of the first and second subfields SF1 and SF2 are respectively set to be 1 and 2, or both to be 1 to express at least gray scale 1 and gray scale 2 by using the first and second subfields SF1 and SF2.

When a given gray scale is only expressed by a weight value W₃ of a third subfield SF3, a discharge is not generated in the first and second subfields SF1 and SF2 and thus a delay of an address discharge is increased. Therefore, the weight value W₃ of the third subfield SF3 is determined to enable the first and second subfields SF1 and SF2 to contribute to expressing the given gray scale. In other words, the weight value W₃ of the third subfield SF3 is set to be less than or equal to a maximum gray scale that can be expressed by using the first and second subfields SF1 and SF2.

When a given gray scale can only be expressed by adding the weight value W₁ of the first subfield SF1 and a weight value W₄ of a fourth subfield SF4, a discharge is not generated in the second and third subfields SF2 and SF3 and thus the delay of the address discharge is increased. Therefore, the weight value W₄ of the fourth subfield SF4 is determined such that the gray scale W₁+W₄ is expressed by the weight values W₁, W₂, and W₃ of the first to third subfields SF1 to SF3. In other words, the gray scale W₁+W₄ is set to be less than or equal to a maximum gray scale W₁+W₂+W₃ that can be expressed by using the first to third subfields SF1 to SF3.

When a weight value W₅ of a fifth subfield SF5 is added and thus a given gray scale W₁+W₂+W₅ is expressed by a sum of the weight values W₁, W₂, and W₅Of the first, second, and fifth subfields SF1, SF2, and SF5, the address discharge is not generated in two consecutive subfields SF3 and SF4. Therefore, the weight value W₅ of the fifth subfield SF5 is set such that the gray scale W1+W₂+W₅ is expressed by a combination of the weight values W₁, W₂, W₃ and W₄ of the first to fourth subfields SF1 to SF4. In other words, the weight value W₅ of the fifth subfield SF5 is set to control the gray scale W₁+W₂+W₅ to be less than or equal to a maximum gray scale W₁+W₂+W₃+W₄ that can be expressed by a sum of weight values W₁, W₂, W₃, and W₄ of the first to fourth subfields SF1 to SF4.

When a weight value of an additional subfield is set by employing the foregoing method, no more than two subfields in which the address discharge is not generated is consecutively arranged.

Briefly, a weight value Wₙ of the n-th subfield is set to control a sum of weight values W₁ to Wₙ₋₃, and Wₙ of first to (n−3)th subfields and the n-th subfield to be less than or equal to a sum of weight values W₁ to Wₙ₋₁ of the first to (n−1)th subfields.

In other words, the weight value Wₙ of the n-th subfield is set to be less than or equal to a sum of weight values Wₙ₋₂ and Wₙ₋₁ of (n−2)th and (n−1)th subfields, as shown in the Equation 1.
W_{n≦W}ₙ₋₂+Wₙ₋₁ [Equation 1]

Where Wₙ denotes a weight value of the n-th subfield, and n is an integer greater than or equal to 3.

However, one field has a limited number of subfields and therefore the number of gray scales expressed by the subfields may be reduced when a weight value of the n-th subfield is set to be relatively too low. On the other hand, when a weight value of a subfield is set to be relatively too high, the subfield may cause contour noise. Thus, it is preferable to set the weight value not to be too high. Therefore, when the weight value of the subfield is relatively low, a weight value Wₙ of the n-th subfield may be set to be equal to a sum of weight values Wₙ₋₂ and Wₙ₋₁ of (n−2)th and (n−1)th subfields as shown in the Equation 2. In addition, when the weight value of the subfield is set to be relatively high, the weight value Wₙ of the n-th subfield may be set to be less than the sum of the weight values Wₙ₋₂ and Wₙ₋₁ of the (n−2)th and (n−1)th subfields to thereby prevent the contour noise.
Wₙ=Wₙ₋₂+Wₙ₋₁ [Equation 2]

Referring to FIG. 4, an arrangement of subfields according to an exemplary embodiment of the present invention embodiment of the present invention will be described in more detail.

FIG. 4 exemplarily illustrates an arrangement of subfields according to an exemplary embodiment of the present invention. FIG. 4 illustrates, for better comprehension and convenience of description, only first to eighth subfields SF1 to SF8 and 56 gray scales, and weight values of the first to eighth subfields SF1 to SF8 are set according to the Equation 2. When arranging the subfields to express gray scales from a gray scale of 1 to a given gray scale, no more than two subfields in which the address discharge is not generated are consecutively arranged in the arrangement of FIG. 4.

The Equation 1 is satisfied for all subfields according to the exemplary embodiments of the present invention, however, it is notable that the Equation 1 may be satisfied only for subfields having relatively low weight values.

In other words, more sustain discharges are generated in subfields of higher weight values, and thus an amount of priming particles generated therein is increased. Thus, the address discharge delay time may be reduced compared to the case of low weight values because the priming particles of the previous subfield may exist even if the address discharge is not generated in two subsequent subfields consecutively.

As described, when arranging the subfields to express gray scales from a gray scale of 1 to a given gray scale, no discharge cell remains turned off for more than two consecutive subfields and is then turned on in another subfield of the same field, and the address discharge delay time can be reduced by using the priming particles generated in the previous subfield.

While this invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

1. A method for expressing gray scales in a plasma display panel using a sum of weight values of a plurality of subfields of turn-on cells, the method comprising:
determining weight values of a first subfield and a second subfield among the plurality of subfields; and
determining a weight value of an n-th subfield among the plurality of subfields, where n is an integer greater than or equal to 3, to be less than or equal to a sum of weight values of an (n−1)th subfield and an (n−2)th subfield among the plurality of subfields,
wherein the determining of the weight value of the n-th subfield is repeated until a weight value of a given subfield is determined.

2. The method of claim 1, wherein the weight value of the n-th subfield is set to be equal to the sum of the weight values of the (n−1)th subfield and the (n−2)th subfield.

3. The method of claim 1, wherein the weight values of the first subfield and the second subfield are respectively set to be 1 and 2.

4. The method of claim 1, wherein the weight values of the first subfield and the second subfield are respectively set to be 1.

5. The method of claim 1, wherein the subfields having the determined weight values of the first and second subfields and the n-th subfield are arranged according to sizes of the weight values, and
when a gray scale is expressed by a sum of the weight values of subfields having the turn-on cells from among the arranged subfields, a position difference between two adjacent subfields having the turn-on cells is less than or equal to 2.

6. The method of claim 2, wherein the weight values of the first subfield and the second subfield are respectively set to be 1 and 2.

7. The method of claim 2, wherein the weight values of the first subfield and the second subfield are respectively set to be 1.

8. The method of claim 2, wherein the subfields having the weight values set by the determining of the weight values of the first and second subfields and the determining of the weight value of the n-th subfield are arranged according to sizes of the weight values, and
when a gray scale is expressed by a sum of the weight values of subfields having the turn-on cells from among the arranged subfields, a position difference between two adjacent subfields having the turn-on cells is less than or equal to 2.

9. A plasma display device comprising:
a plasma display panel having a plurality of discharge cells, the plasma display panel being for expressing gray scales in the plurality of discharge cells using a sum of weight values of subfields selected from among a plurality of subfields having respective weight values; and
a controller for selecting subfields of which the discharge cells are to be turned on from among the plurality of subfields according to input gray scales, and for controlling an arrangement of the subfields such that no discharge cell remains turned off for more than two consecutive subfields and is then turned on in another subfield of a same field when arranging the subfields to express gray scales from a gray scale of 1 to a given gray scale.

10. The plasma display device of claim 9, wherein the controller controls the weight values of a first subfield and a second subfield among the plurality of subfields to be 1, respectively.

11. The plasma display device of claim 9, wherein the controller controls the weight values of a first subfield and a second subfield among the plurality of subfields to be 1 and 2, respectively.

12. The plasma display device of claim 9, wherein the controller controls the weight value of an n-th subfield to be less than or equal to a sum of the weight values of an (n−1)th subfield and an (n−2)th subfield among the plurality of subfields.

13. The plasma display device of claim 9, wherein the controller controls the weight value of an n-th subfield to be equal to a sum of the weight values of an (n−1)th subfield and an (n−2)th subfield.

14. A method for expressing gray scales in a plasma display panel having a plurality of discharge cells, using a sum of weight values of a plurality of subfields of turned-on discharge cells among the plurality of discharge cells, the method comprising:
determining the weight values of the subfields such that the weight value of each subfield except for first and second subfields is less than or equal to a sum of the weight values of two previous subfields among the plurality of subfields when the subfields are arranged in an increasing order of their respective weight values.

15. The method of claim 14, further comprising:
driving the discharge cells to express the gray scales such that none of the discharge cells is turned off for at least three consecutive subfields of a field and is then turned on in a subfield of the field after the at least three consecutive subfields.

16. The method of claim 14, wherein the weight value of each subfield except for the first and second subfields is determined to be equal to the weight values of two immediately previous subfields among the plurality of subfields.

17. The method of claim 14, wherein the weight values of each subfield except for the first and second subfields is determined to be less than the weight values of two immediately previous subfields among the plurality of subfields.

18. The method of claim 14, wherein the weight values of the first and second subfields are set to 1 and 2, respectively.

19. The method of claim 14, wherein the weight values of the first and second subfields are both set to 1.
